(19) United States
(12) Patent Application Publication
(10) Pub. No.: US 2024/0242008 A1
(43) Pub. Date: Jul. 18, 2024

(54) COMPUTER TECHNOLOGY FOR ENSURING SUFFICIENCY OF SENSOR SET USED TO SUPPORT DIGITAL TWIN SIMULCRA

(71) Applicant: INTERNATIONAL BUSINESS MACHINES CORPORATION, ARMONK, NY (US)

(72) Inventors: Atul Mene, Morrisville, NC (US); Tushar Agrawal, West Fargo, ND (US); Jeremy R. Fox, Georgetown, TX (US); Sarbajit K. Rakshit, Kolkata (IN)

(21) Appl. No.: 18/154,137

(22) Filed: Jan. 13, 2023

(51) Int. Cl. G06F 30/27

(52) U.S. Cl. CPC G06F 30/27; G06F 2111/02

(57) ABSTRACT

Computer technology where predictive analytics are used in connection with a digital twin simulation to predict an issue with a target (that is, environment, physical object and/or process). Based on the predicted issue, a machine learning algorithm is used to reconfigure the sensor set that monitors the target to more accurately, precisely and/or quickly detects a real world occurrence of the predicted issue.

### BACKGROUND

The present invention relates generally to the field of digital twins and the design of sensor hardware sub-systems for ensuring that digital twins track their physical world counterparts in a relatively accurate manner.

The Wikipedia entry for “Digital Twin” (as of Oct. 11, 2022) states, in part, as follows: “A digital twin is a virtual representation of a real-world physical system or process (a physical twin) that serves as the indistinguishable digital counterpart of it for practical purposes, such as system simulation, integration, testing, monitoring, and maintenance. A digital twin could (but not must) be used in real time and regularly synchronized with the corresponding physical system. As an example of a real time digital twin, an object being studied—for example, a wind turbine—may be outfitted with various sensors related to vital areas of functionality. These sensors produce data about different aspects of the physical object's performance, such as energy output, temperature, weather conditions and more. This data is then relayed to a processing system and applied to the digital copy. Though the concept originated earlier, the first practical definition of a digital twin originated from NASA in an attempt to improve physical-model simulation of spacecraft in 2010. Digital twins are the result of continual improvement in the creation of product design and engineering activities. Product drawings and engineering specifications have progressed from handmade drafting to computer-aided drafting/computer-aided design to model-based systems engineering and strict link to signal from the physical counterpart.” (footnotes omitted)

In some instances, this document may break digital twin simulacra into four categories: (i) digital twin that simulates a product (for example, a jet engine or an entire jet); (ii) digital twin that simulates a process (for example, a maintenance process performed on jet engines); (iii) a physical environment (for example, an industrial environment, such as a factory that produces jet engine); and (iv) hybrids of the foregoing there types. In this document, digital twins may be referred to as digital twin data sets in order to help the reader remain cognizant of the fact that the digital twin is a set of machine readable data, which typical includes multiple attribute values corresponding to many attribute fields. For example, one attribute field might be a head on visual view of a jet engine as it is currently believed to exist in its physical world, where the attribute value is a machine readable bit map image of the head on visual view. counterpart. Another example attribute value is the speed at which the jet engine is spinning (if at all) at the current time.

European patent application EP3839969A1 (“Bulut”) states, in part, as follows: “embodiments . . . may additionally or alternatively dynamically adjust settings of connected physical sensors so as to configure the incoming physical data set to better match the input information requirements of the digital twin. Adjustable operation settings of the physical sensors might include sensor sampling rate (i.e. frequency of measurement acquisition), sensor precision or accuracy level and/or sensor activation/deactivation (i.e. turning individual sensors ON/OFF). The system is therefore able, based on detected input information needs for the digital model, to curate the particular patient dataset which is provided to the digital model for generating the desired set of output information. Adjustment of the physical sensor settings may be performed also with reference to one or more optimization criteria or constraints. The optimization criteria may take different forms. They may include criteria for improving efficiency of the system, for instance by minimizing the number of active sensors and the rate of data collection while still meeting the input information requirements. This may save power and processing resource.”

### SUMMARY

According to an aspect of the present invention, there is a method, computer program product and/or system that performs the following operations (not necessarily in the following order): (i) instantiating a real world instantiation of an environment (or process of physical object) and a plurality of sensor devices, with the plurality of sensor devices being configured in an initial configuration; (ii) creating an environment type digital twin of the real world instantiation of the environment; (iii) starting a digital twin simulation of the real world environment to provide digital twin simulation output relating to simulated operations and/or status of simulated objects involved in the digital twin simulation; (iv) applying predictive analytics to predict a potential issue that has occurred or may occur in the real world instantiation of the environment; (v) automatically, by machine logic, determining an improved sensor configuration that will more quickly, precisely and/or accurately detect a real world instantiation of the potential issue in the real world instantiation of the environment; and (vi) automatically, by machine logic, reconfiguring the plurality of sensors from the initial configuration to the improved configuration.

### BRIEF DESCRIPTION OF THE DRAWINGS

FIGS. 1A and 1B, taken together, form a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flowchart showing a second embodiment method; and

FIG. 5 is a flowchart showing a first embodiment method performed, at least in part, by the first embodiment system.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

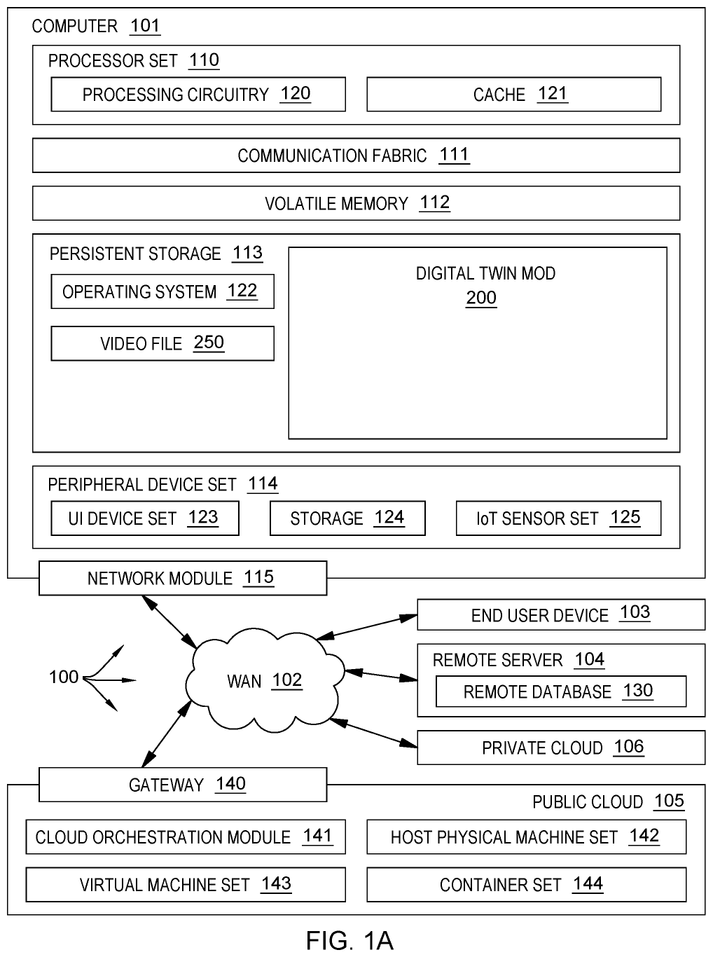

As shown in FIGS. 1A and 1B of this document, computing environment 100 contains an example of an environment for the execution of at least some of the computer code involved in performing the inventive methods, such as digital twin module (“mod”) 200 (also herein sometimes referred to as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, video file 250 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, container set 144 and manufacturing environment 158 (including moving assembly line 150, in-progress assemblies 152, 154, 156 and sensor set 159 (including first camera 160, second camera 162, third camera 164 and fourth camera 166)).

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### II. Example Embodiment

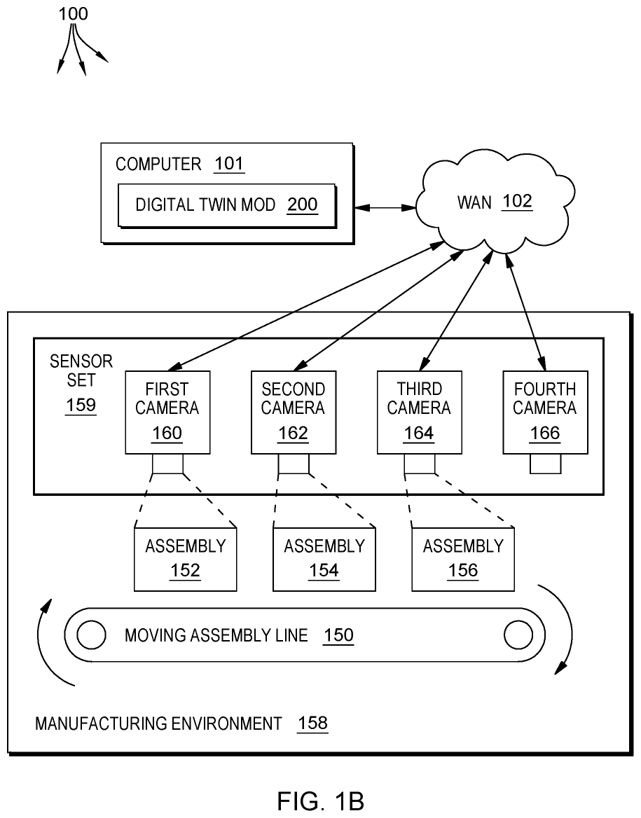

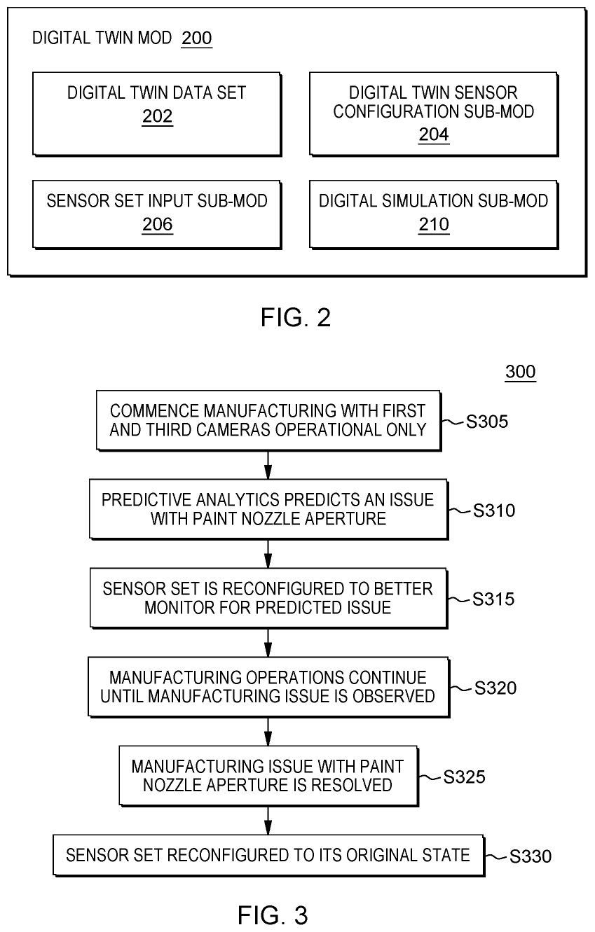

Computing environment 100 is an environment in which an example method according to the present invention can be performed. As shown in FIG. 3, flowchart 300 shows an example method according to the present invention. As shown in FIG. 2, block 200 performs or controls performance of at least some of the method operations of flowchart 300. This method and associated software will now be discussed, over the course of the following paragraphs, with extensive reference to the blocks of the first three figures.

Before going into the operations of flow chart 300, manufacturing environment 158 will be briefly explained. Moving assembly line 150 has three assembly stations along its length: (i) at the first station, where assembly 152 is located and where first camera 160 is directed, the banana is inserted into its peel and sealed up; (ii) at the second station, where assembly 154 and where second camera 162 is directed, the banana assembly is painted yellow; and (iii) at the third station, where assembly 156 is located and where third camera 164 is directed, the banana assembly is subjected to a squeeze to make sure its firmness is within a predetermined range that is suitable for banana assemblies. After the banana assembly rolls past the third station it goes thru a transfer stage (not separately shown in the drawings), where fourth camera 166 is directed. Digital twin data set 202 is a digital twin of the entirety of manufacturing environment 158 (an environment type of digital twin). This environment digital twin 202 includes within it physical product type digital twins (not separately shown in FIG. 1B) of banana assemblies 152, 154, 156 as they pass thru the various stages of manufacturing environment 158. This environment digital twin 202 further includes within it a process type digital twin (not separately shown in FIG. 1B) which represents the process of manufacturing the banana assemblies (encapsulation in peel assembly operation at the first station, yellow painting operation at the second station, squeeze test operation at the third station and the transfer operation at the end of moving assembly line 150).

Processing begins at operation S305, where moving assembly line 150 is driving the manufacturing process to continuously produce banana assemblies. More specifically, and as shown in FIG. 1B, assemblies 152, 154 and 156 are being actively worked on. While this is happening, digital simulation sub-mod 210 is running a simulation of the manufacturing environment 158 using digital twin data set 202, which includes many, many pertinent attributes of actual, physical manufacturing environment 158. In this example, the simulation is actually running a couple minutes ahead of the corresponding real world manufacturing process. Alternatively, the simulation could be running simultaneously or running behind the real world manufacturing process.

Turning now to the way that sensor set 159 monitors the manufacturing process and the assemblies that are being manufactured by the manufacturing process. In this example embodiment, all of the available sensor devices in the sensor set are cameras. Alternatively, any other types of sensor device(s), now known or to be developed in the future, may be included in the sensor set, such as microphones, temperature sensors, pressure sensors, motion detectors, carbon dioxide detectors, etc. In this example, at the time of operation S305, only the first camera 160 and the third camera 164 are active. This is because it has been historically observed that most manufacturing issues occur at the first station (insertion of banana into peel) or at the third station (the banana firmness test). By using only the first and third cameras, communication bandwidth is conserved and wear and tear on the inactive second and fourth cameras is minimized. Normally this sensor configuration works well and most manufacturing issues, and consequent divergences between the digital twin simulation and the reality on the factory floor are captured in real time by the first and/or third cameras. More specifically, the manner in which it is determined that only the first and third cameras are really needed is that digital twin sensor configuration sub-mod 204 leverages machine learning algorithms included in sub-mod 204 to automatically identify and adjust the most relevant sensor settings based on the specific input information requirements of the digital twin. In this particular example, the relevant sensor setting is which of the cameras 160, 162, 164, 166 needs to be active and these machine learning algorithms are based on historical experience with manufacturing environment 158 and other similar manufacturing environments.

As operation S305 is proceeding both as a simulation of manufacturing environment 158 at sub-mod 210 and in the real world in manufacturing environment 158 itself, processing proceeds to operation S310, where predictive analytics programmed into digital simulation sub-mod 210 predicts that wear and tear on an aperture of a paint spraying machine (not shown in the drawings) at the second assembly station (where the painting-the-banana-yellow operation occurs) will cause blue paint to mix into the outgoing stream of yellow paint so that any banana assemblies are painted green instead of yellow. Predictive analytics are thusly implemented to forecast potential changes in the physical environment—in this example, a worn aperture and consequent green bananas.

Processing proceeds to operation S315, where, in response to the detection of the potential problem with the aperture of the paint spraying device, digital sensor sub-mod 204 proactively adjusts sensor settings to ensure the feedback from sensor set 159 remains accurate and up-to-date. More specifically, in this example, sensor set 159 is reconfigured by turning on second camera 162 so that first camera 160, second camera 162 and third camera 164 are all active (fourth camera 166 remains off). In this way, if the blue paint does leak into the outgoing paint stream, and the banana assemblies start turning green instead of yellow, then the feedback from the sensor set, specifically from second camera 162, will pick up the issue as quickly as possible as it starts to occur in the real world instantiation of manufacturing environment 158. In other words, the sensor set is reconfigured automatically based on predictions made in connection with running the ongoing digital twin simulation. The following sub-section will mention some of the other various ways that sensor sets may be reconfigured (for example, change sampling rate, change location of sensor hardware, etc.). In some embodiments, custom software tools or applications are provided, which that allow users to easily and efficiently configure data collection for a digital twin without the need to manually adjust physical sensor settings.

Processing proceeds to operation S320, where manufacturing operations continue until the predicted problem occurs in the real world instantiation of manufacturing environment 158. During operation S320, images captured by the active cameras of sensor set 159 are received by sensor input sub-mod 206 of digital twin mod 200. In this way, second camera 162 will capture images of the green banana problem starting to occur and this will be detected in the input received therefrom by sub-mod 206.

Processing proceeds to operation S325 where the manufacturing issue with the paint spraying station is resolved. In this example, a plate with the worn aperture is replaced by a new replacement part that has an unworn aperture that ensures that the paint is yellow again and not green.

Processing proceeds to operation S330, where digital twin sensor configuration sub-mod reconfigures the sensor set to its original state by turning off camera 162.

### III. Further Comments and/or Embodiments

A Digital Twin is a virtual model designed to accurately reflect a physical object. The object being studied, for example, a wind turbine, is outfitted with various sensors related to vital areas of functionality. These sensors produce data about different aspects of the physical object's performance, such as energy output, temperature, weather conditions and more. This data is then relayed to a processing system and applied to the digital copy. The digital twin simulation is created based on the IoT (internet of things) feeds from various parts of the machines, their working conditions, etc.

Some embodiments of the present invention recognize one, or more, of the following facts, potential problems and/or potential areas for improvement with respect to the current state of the art: (i) the digital twin computing system creates a digital twin model from the sensor feed receives from any physical asset; (ii) the accuracy of a digital twin model depends on the quality of sensor feed; (iii) missing, inaccurate, misconfigured, or delayed sensor feeds can seriously adversely impact the sensor feeds; and/or (iv) there is a need to ensure if the digital twin computing system generated model is accurate, then modifying the digital twin model to improve the accuracy as required.

A method according to an embodiment of the present invention includes the following operations (not necessarily in the following order): (i) a system/method to improve accuracy of digital twin simulation comprising: (ii) identifying, for a device that has a digital twin, a set of sensors for the device that are used in generating/operating the digital twin; (iii) determining, for each sensor, one or sensor feeds including a type of data captured, and a relative location on or around the device, and/or a feature of the device being monitored; (iv) analyzing the sensor feeds to generate a knowledge corpus; (v) determining, based on the sensor feeds, the device output, and the knowledge corpus, a deviation of the digital twin, wherein the deviation represents differences between the device and the digital twin; and (vi) altering the digital twin to improve the accuracy and/or efficiency of the digital twin.

A method according to an embodiment of the present invention includes the following operations (not necessarily in the following order): (i) altering includes adding additional sensor to increase the accuracy of digital twin, including types of sensors and/or number sensors; (ii) altering includes removing a sensor with no loss in accuracy but with a reduction in cost thereby increasing the efficiency of the digital twin; and (iii) identifying a scenario in which a digital twin will provide a benefit/is required, including a predicted accuracy (or minimum variance) for the digital twin to provide the benefit, and the scenario includes a set of sensors and sensor feeds.

Some embodiments of the present invention may include one, or more, of the following operations, features, characteristics and/or advantages: (i) assists companies that have made significant investments in AI (artificial intelligence) and its applications across industries; (ii) assists companies that have made significant investments in the digital twin space; (iii) evaluates the accuracy and quality of digital twin models of an asset; (iv) compares the current digital twin model simulation and the actual performance of the asset in a given context to identify deviations/delta in the performance; (v) recommends how the asset should be modified with additional sensors or replacing the existing sensors to improve the quality and accuracy of digital twin model in that context to reduce cost and improve the ROI (return on investment); and/or (vi) considers the asset's health to identify sensor feed sufficiency.

Some embodiments of the present invention may include one, or more, of the following operations, features, characteristics and/or advantages: (i) includes accuracy evaluation for a digital twin; (ii) evaluates the accuracy and quality of digital twin models of any asset and recommends how the physical asset is to be modified with additional sensors or replacing the existing sensors so that quality of digital twin model of the asset can be improved; (iii) includes external monitoring for additional sensor inputs; (iv) identifies if one or more external sensors, scanning modules are to be installed around the physical asset so that the digital twin model of the physical asset can be improved; (v) includes deviation/delta processing between physical asset and the digital twin; (vi) compares the deviation between the digital twin model simulation and the actual performance of the physical asset; and/or (vii) includes the context of using a digital twin and accordingly identifies at which point quality and accuracy of the digital twin model is to be improved for the physical asset.

Some embodiments of the present invention may include one, or more, of the following operations, features, characteristics and/or advantages: (i) considers the cost of improving the digital twin ROI; (ii) based on the context of using a digital twin simulation, the cost of improving the quality and accuracy of digital twin model, the system will identify how much quality and accuracy of the digital twin model is sufficient for the said physical asset; (iii) uses sensor feed sufficiency; and/or (iv) based on the health condition of any machines, the system will identify how much sensor feed is sufficient to create a digital twin model, so that with optimum computation, the digital required digital twin model can be created for the physical asset (for example, volume, velocity, variety, veracity, value of the sensor feeds (the five (5) V's of big data).

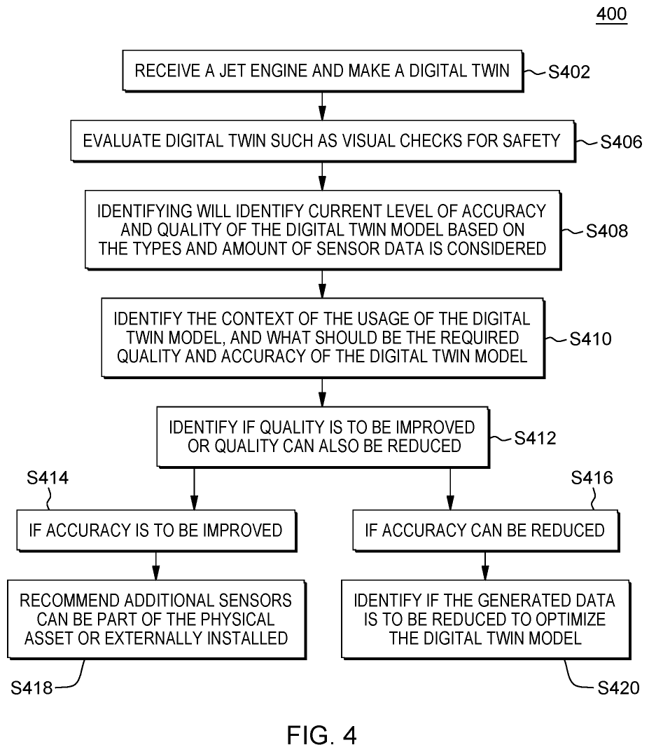

According to embodiments of the present invention, FIG. 4 flowchart 400, describes a digital twin model for accuracy and evaluation quality. The system evaluates the digital twin model and identifies if the quality of digital twin model can be improved. Flowchart 400 includes: receive a jet engine and make a digital twin block S402; evaluate digital twin such as visual checks for safety block S406; identifying will identify current level of accuracy and quality of the digital twin model based on the types and amount of sensor data is considered block S408; identify the context of the usage of the digital twin model, and what should be the required quality and accuracy of the digital twin model block S410; identify if quality is to be improved or quality can be reduced block S412; if accuracy is to be improved block S414; if accuracy can be reduced block S416; recommend additional sensors can be art of the physical asset or externally installed block S418; and identify if the generated data is to be reduced to optimize the digital twin model block S420.

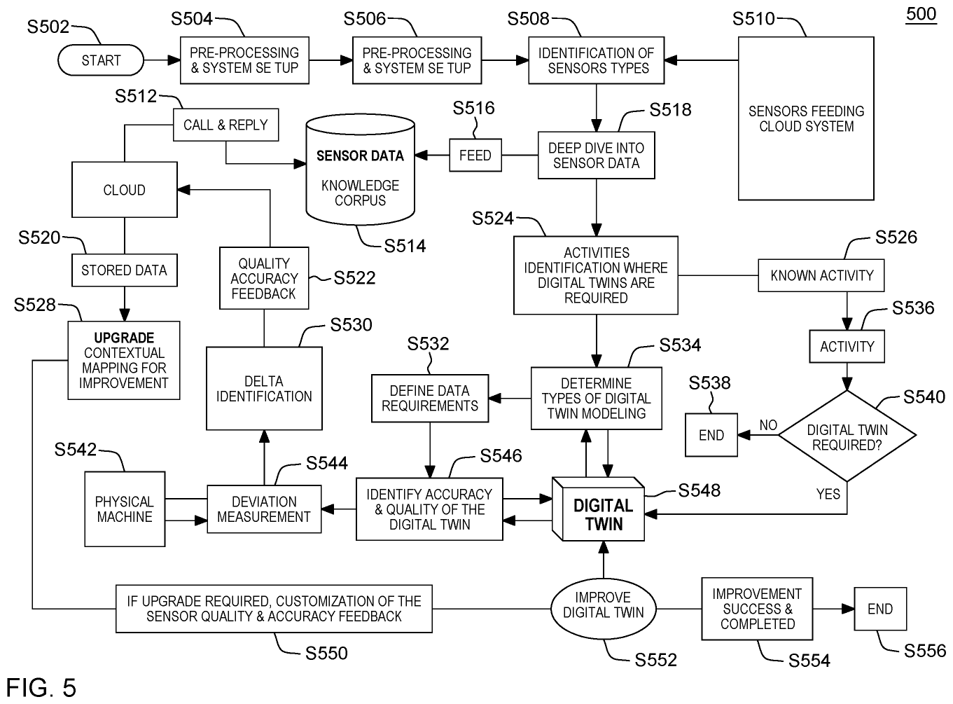

As shown in FIG. 5, flowchart 500 includes: start block S502; pre-processing and system setup block S504; defining objective block S506; identification of sensors type block S508; sensors feeding cloud system block S510; call and reply block S512; sensor data knowledge corpus storage S514; feed block S516; deep dive into sensor data block S518; stored data block S520; quality accuracy feedback block S522; activities identification where digital twins are required block S524; known activity block S526; upgrade contextual mapping for improvement block S528; delta identification block S530; define data requirements block S532; determine types of digital twin modeling block S534; activity block S536; end block S538; digital twin required decision block S540; physical machine block S542; deviation measurement block S544; identify accuracy and quality of the digital twin block S546; digital twin block S548; if upgrade required, customization of the sensor quality and accuracy feedback block S550; improve digital twin block S552; improvement success and completed block S554; and end block S556.

Some embodiments of the present invention may include one, or more, of the following operations, features, characteristics and/or advantages: (i) includes pre-processing setup of scope (FIG. 5, item S504) using an AI enabled system to evaluate the quality of the digital twin model and identifies when the quality and accuracy of the digital twin models of any asset need to be improved; (ii) includes defining objective—comparing actual results with digital twins (FIG. 5, item S506) by gathering different digital twin models; (iii) compares the value between the actual result and the digital twin simulated result; (iv) performs identification of the types of sensor(s) (FIG. 5, item S508) by identifying what types of sensor data are being used for digital twin model creation; and/or (v) includes the following examples of various sensor feeds: volume, velocity, variety, veracity, and value of the sensor feeds.

Some embodiments of the present invention may include one, or more, of the following operations, features, characteristics and/or advantages: (i) includes sensor data “deep dive” (FIG. 5, item S518) into machine parts (of the digital twin) where the system will be consider a digital twin model of different machine parts and identifies what type of sensor feeds are captured; (ii) includes analysis of the sensor data (FIG. 5, item S510) where the system analyzes the sensor feeds to determine what types of data are captured with the sensor feeds; (iii) includes simulated model impacts (FIG. 5, items S536 and S540) where the system identifies different types of simulated models and their captured data for the simulated result; (iv) includes knowledge corpus creation (FIG. 5, item S514) where, based on historically captured information, the system creates a knowledge corpus about the digital twin model; (v) includes activities identification where digital twins are required (FIG. 5, item S524) by identifying different types of activities where a digital twin computing system is required; and/or (vi) includes historical learning (FIG. 5, item S534) and determining the types of digital twin modeling for different types of activities where the system identifies what types of digital twin model is required, where these can be done from historical learning.

Some embodiments of the present invention may include one, or more, of the following operations, features, characteristics and/or advantages: (i) includes define data requirements (FIG. 5, item S532) where the system identifies how much data is considered for digital twin model creation for different activities; (ii) includes identifying the accuracy and quality of the digital twin (FIG. 5, items S530 and S544) where the system identifies the accuracy and quality from different historical digital twins; (iii) includes deviation measurement where the quality and accuracy of the digital twin model will be created based on the historically gathered deviation between actual and digital twin simulation results; (iv) includes cloud system identification and quality and accuracy feedback (FIG. 5, item S522) where the cloud hosted AI system evaluates the quality and accuracy of various digital twin models; and/or (v) includes Cloud System Identification and Quality & Accuracy Feedback where the cloud hosted AI system evaluates the quality and accuracy of various digital twin models.

Some embodiments of the present invention may include one, or more, of the following operations, features, characteristics and/or advantages: (i) includes contextual definition for a digital twin where the system identifies the context of any activity where a digital twin is required and identifies what activity performs the current asset; (ii) includes Contextual Definition for Digital Twin (FIG. 5, item S520) where the system identifies the context of any activity where a digital twin is required; (iii) identifies what activity performs the current asset; and/or (iv) maps the accuracy & quality requirements (FIG. 5, item S546) to a digital twin model where the system identifies how much accuracy and quality of the digital twin model is required for the context.

Some embodiments of the present invention may include one, or more, of the following operations, features, characteristics and/or advantages: (i) includes analyzing the current digital twin and any identified shortcomings (FIG. 5, items S528) where the system identifies if the current digital twin model will be evaluated by the AI model; (ii) determines if an Upgrade Required where the system identifies if the physical asset needs to be upgraded to create the required quality of digital twin model; (iii) determines what types of sensors are required where the system identifies what types of sensors are to be installed in different parts of the machine or external sensors are to be installed; (iv) gathers data to improve the sensor feedback experience (FIG. 5, items S550 and S552) where the system gathers the required data and improves the quality and accuracy of the digital twin model; and/or (v) performs the customization of the quality and accuracy recommendation feedback (FIG. 5, item S554) where the system identifies if gathered data from various sensors are to be customized to make the required quality and accuracy of digital twin model.

Some embodiments of the present invention may include one, or more, of the following operations, features, characteristics and/or advantages: (i) focuses on the remediation of sensory data (configuration, audit, etc.); (ii) monitors feeds to determine the accuracy and integrity of input so that generative technologies do not need to be used; (iii) monitors generated data to see if it needs to be reduced or modified; and/or (iv) focuses on various topics including comparing results, analyzing and improving digital twin simulation so future analysis would be more accurate.

Some embodiments of the present invention may include one, or more, of the following operations, features, characteristics and/or advantages: (i) compares the current digital twin model simulation and the actual performance of the asset in each context to identify deviations/delta in the performance to create a knowledge corpus; (ii) leverages historical learning to recommend how the asset should be modified with additional sensors or replacing the existing sensors to improve the quality and accuracy of digital twin model in that context to reduce cost and improve the return on investment; (iii) identifies scenarios in which a digital twin provides a benefit including predicted accuracy (or minimum variance) for the digital twin to provide benefit, including the set of sensors and data feeds; (iv) considers the asset's health to identify sensor feed sufficiency; (v) uses data visualization techniques and interactive dashboards to provide real-time feedback on the accuracy and reliability of the digital twin; (vi) identifies opportunities for improvement or optimization of data collection strategies; (vii) facilitates collaboration with subject matter experts and other stakeholders to identify and prioritize the most critical input information for the digital twin; (viii) design custom data collection strategies that focus on these key areas; (ix) monitor the feed to determine accuracy and integrity of input so that generative technologies do not need to be used and the root problem can be addressed; and/or (x) generate data to see if it needs to be reduced or modified.

While a computer system and method for configuring data collection for a digital twin may have the ability to adjust physical sensor settings, this does not necessarily mean that it is the best or only option for meeting the input information requirements of the digital twin. There may be other, potentially more effective or efficient, ways of achieving this without adjusting the physical sensor settings. Additionally, adjusting physical sensor settings without proper oversight or consideration of potential impacts on the accuracy and reliability of the collected data may be detrimental and should be avoided. It is important to carefully evaluate and consider all options before making any adjustments to physical sensor settings.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Set of thing(s): does not include the null set; “set of thing(s)” means that there exist at least one of the thing, and possibly more; for example, a set of computer(s) means at least one computer and possibly more.

What is claimed is:

1. A computer-implemented method (CIM) comprising:
instantiating a real world instantiation of an environment that includes object(s) within the environment and process(es) within the environment and a plurality of sensor devices, with the plurality of sensor devices being configured in an initial configuration;
creating an environment type digital twin of the real world instantiation of the environment;
starting a digital twin simulation of the real world environment to provide digital twin simulation output relating to simulated operations and/or status of simulated objects involved in the digital twin simulation;
applying predictive analytics to predict a potential issue that has occurred or may occur in the real world instantiation of the environment; and
automatically, by machine logic, determining an improved sensor configuration that will more quickly, precisely and/or accurately detect a real world instantiation of the potential issue in the real world instantiation of the environment; and
automatically, by machine logic, reconfiguring the plurality of sensors from the initial configuration to the improved configuration.

2. The CIM of claim 1 further comprising:
subsequent to the reconfiguration of the plurality of sensors, receiving sensor output from the plurality of sensors;
detecting occurrence of the potential issue in the real world instantiation of the environment; and
correcting the potential issue in the real world instantiation of the environment.

3. The CIM of claim 1 wherein the environment is a manufacturing facility that manufactures physical products.

4. The CIM of claim 1 wherein the plurality of sensors include at least one of the following sensor types: camera, microphone, temperature sensor, motion detector and/or carbon dioxide detector.

5. The CIM of claim 1 further comprising:
applying a machine learning algorithm to determine the initial sensor configuration; and
wherein the determination of the improved sensor configuration includes applying the machine logic algorithm to determine the improved sensor configuration.

6. The CIM of claim 1 wherein the initial sensor configuration and the improved sensor configuration include at least one of the following types of sensor configuration attribute(s): identity of active and inactive sensors, sensor location, sensor positioning, sensor sampling rate and/or identity of sensor device models.

7. A computer-implemented method (CIM) comprising:
instantiating a real world instantiation of a physical object and a plurality of sensor devices, with the plurality of sensor devices being configured in an initial configuration;
creating an object type digital twin of the real world instantiation of the object;
starting a digital twin simulation of the real world object to provide digital twin simulation output relating to simulated operations and/or status of the digital twin simulation of the real world object;
applying predictive analytics to predict a potential issue that has occurred or may occur in the real world instantiation of the physical object; and
automatically, by machine logic, determining an improved sensor configuration that will more quickly, precisely and/or accurately detect a real world instantiation of the potential issue in the real world instantiation of the physical object; and
automatically, by machine logic, reconfiguring the plurality of sensors from the initial configuration to the improved configuration.

8. The CIM of claim 7 further comprising:
subsequent to the reconfiguration of the plurality of sensors, receiving sensor output from the plurality of sensors;
detecting occurrence of the potential issue in the real world instantiation of the physical object; and
correcting the potential issue in the real world instantiation of the physical object.

9. The CIM of claim 7 wherein the physical object is a vehicle or a portion of a vehicle.

10. The CIM of claim 7 wherein the plurality of sensors include at least one of the following sensor types: camera, microphone, temperature sensor, motion detector and/or carbon dioxide detector.

11. The CIM of claim 7 further comprising:
applying a machine learning algorithm to determine the initial sensor configuration; and
wherein the determination of the improved sensor configuration includes applying the machine logic algorithm to determine the improved sensor configuration.

12. The CIM of claim 1 wherein the initial sensor configuration and the improved sensor configuration include at least one of the following types of sensor configuration attribute(s): identity of active and inactive sensors, sensor location, sensor positioning, sensor sampling rate and/or identity of sensor device models.

13. A computer-implemented method (CIM) comprising:
instantiating a real world instantiation of a process and a plurality of sensor devices, with the plurality of sensor devices being configured in an initial configuration;
creating an object type digital twin of the real world instantiation of the process;
starting a digital twin simulation of the process to provide digital twin simulation output relating to simulated operations and/or status of the digital twin simulation of the real world process;
applying predictive analytics to predict a potential issue that has occurred or may occur in the real world instantiation of the process; and
automatically, by machine logic, determining an improved sensor configuration that will more quickly, precisely and/or accurately detect a real world instantiation of the potential issue in the real world instantiation of the process; and
automatically, by machine logic, reconfiguring the plurality of sensors from the initial configuration to the improved configuration.

14. The CIM of claim 13 further comprising:
subsequent to the reconfiguration of the plurality of sensors, receiving sensor output from the plurality of sensors;
detecting occurrence of the potential issue in the real world instantiation of the process; and
correcting the potential issue in the real world instantiation of the process.

15. The CIM of claim 13 wherein the physical object is a vehicle or a portion of a vehicle.

16. The CIM of claim 13 wherein the plurality of sensors include at least one of the following sensor types: camera, microphone, temperature sensor, motion detector and/or carbon dioxide detector.

17. The CIM of claim 13 further comprising:
applying a machine learning algorithm to determine the initial sensor configuration; and
wherein the determination of the improved sensor configuration includes applying the machine logic algorithm to determine the improved sensor configuration.

18. The CIM of claim 1 wherein the initial sensor configuration and the improved sensor configuration include at least one of the following types of sensor configuration attribute(s): identity of active and inactive sensors, sensor location, sensor positioning, sensor sampling rate and/or identity of sensor device models.
